(19) United States
(12) Patent Application Publication
(10) Pub. No.: US 2017/0107735 A1
(43) Pub. Date: Apr. 20, 2017

(54) LAND-BASED RIG WITH ON-BOARD CRANE

(71) Applicant: Ls3 Solutions, LLC, Houston, TX (US)

(72) Inventor: Philip Willem WASTERVAL, Houston, TX (US)

(21) Appl. No.: 15/298,446

(22) Filed: Oct. 20, 2016

Related U.S. Application Data
(60) Provisional application No. 62/243,697, filed on Oct. 20, 2015.

(51) Int. Cl. E04H 12/34; B66C 23/18; E21B 15/00; E04H 12/00

(52) U.S. Cl. CPC E04H 12/34; E04H 12/00; B66C 23/18; E21B 15/00

(57) ABSTRACT

A method of assembling a land-based rig is provided, which includes providing a set of modules that can be assembled together to form the rig, wherein the modules include an on-board crane, and assembling the modules into the rig, wherein at least some of the modules are assembled into the rig using the on-board crane.

### BACKGROUND OF THE INVENTION

Field of the Invention

The present invention generally relates to a self-erecting, modular, land-based rig for drilling wells, more particularly, oil and gas wells, wherein the modules thereof are assembled with the use of an integral on-board crane.

Description of the Related Art

Modular oil and gas rigs used for drilling wells for oil and gas exploration and production are known. Such modular rigs typically include a plurality of modular elements, each of which is assembled into the rig with a mobile crane. However, the dimensions and weights of the modules which are assembled into the modular rig are limited by federal and local laws regarding the transportation thereof on highways, as well as by highway underpass clearances. In protected areas such as wetlands, the dimensions and weights of mobile rig modules are limited by federal and local laws. Additionally, the mobile cranes used for assembly and disassembly of modular rigs are expensive and, when demand to drill new well bores is high, in short supply. Because few rig operators or erection service providers assemble and disassemble rigs in sufficient numbers to justify ownership of a mobile crane, the mobile cranes are rented or leased at considerable expense, and often significant lead times or waits for availability. This limits the number of rigs that can be assembled and disassembled, which at periods of peak drilling activity, reduces the number of wells ultimately drilled.

### SUMMARY OF THE INVENTION

In an embodiment, a method of assembling a land-based rig is provided, which includes providing a set of modules that can be assembled together to form the rig, wherein the modules include an on-board crane, and assembling the modules into the rig, wherein at least some of the modules are assembled into the rig using the on-board crane.

In another embodiment, a lifting apparatus for a drilling rig is provided. The lifting apparatus includes a crane platform having a first side, a second side, and a perimeter wall extending between the first wall and the second wall, a plurality of supports extending from the crane platform, wherein two of the supports are moveably connected to the crane platform at a first distance from the first side and at least one additional support is moveably connected to the crane platform at a second distance from the first surface, different than the first distance, a crane on the crane platform, and a lifting cylinder attached to the crane platform. The plurality of supports are moveable with respect to the crane platform between a first position extending generally parallel to the earth's surface and a second position wherein they extend upwardly from the earth's surface.

In a further embodiment, a modular rig is provided. The rig includes a first box, a crane platform having a first side, a second side, and a perimeter wall extending between the first wall and the second wall, a plurality of supports extending from the crane platform, wherein at least one of the supports is moveably connected at a first end thereof to the crane platform at a first distance from the first side of the crane platform and at a second end thereof to the first box, and at least one additional support is moveably connected to the crane platform at a second distance from the first surface, different than the first distance, and at a second end thereof to the first box. A crane is located on the crane platform, and a lifting cylinder is attached at a first end thereof to the crane platform and at a second end thereof to a component of the first box. The plurality of supports are moveable with respect to the crane platform between a first position extending generally parallel to the earth's surface and a second position wherein they extend upwardly from the earth's surface.

### BRIEF DESCRIPTION OF THE DRAWINGS

So that the manner in which the above recited features of the present invention can be understood in detail, a more particular description of the invention, briefly summarized above, may be had by reference to the embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a fully assembled mobile rig with an on board crane;

FIG. 2 is a perspective view of the fully assembled lower box of the mobile rig of FIG. 1;

FIG. 3 is a perspective view of the lower box of FIG. 2, wherein a portion thereof is being delivered off the back of a truck;

FIG. 4 is a plan view of the lower box of FIG. 2;

FIG. 5 is a perspective view of one end of the lower box showing a connection paradigm for connecting the crane to the lower box;

FIG. 6 is a side view of the crane and lower box of FIG. 5, showing the as-delivered state of the crane in its collapsed state;

FIG. 7 is a side view of the crane and lower box of FIG. 6 being raised to its upright position;

FIG. 8 is a side view of the crane and lower box of FIG. 7 showing the crane it its fully upright state;

FIG. 9 is a perspective view of the partially assembled rig, wherein the upper box is positioned on the lower box and a first strongback is being lifted off of a trailer by the crane;

FIG. 10 is FIG. 9 is a perspective view of the partially assembled rig, wherein the strongbacks are located on the upper box and a first section of the rig floor is being positioned on the strongbacks using the crane;

FIG. 11 is a perspective view of the partially assembled rig, showing the last section of the rig floor being delivered to it rig position by the crane;

FIG. 12 is a perspective view of the drawworks being delivered to the rig floor by the crane;

FIG. 13 is a perspective view of the partially assembled rig, wherein the tool shed has been positioned on a portion of the strongbacks and the base of the mast is about to be lifted by the crane;

FIG. 14 is a perspective view of the partially assembled rig showing the crane supporting the base of the mast as it is being connected to the rig floor;

FIG. 15 is a perspective view of the partially assembled rig, showing the drillers cabin being positioned over a portion of the strongbacks by the crane;

FIG. 16 is a perspective view of the partially assembled rig, showing a first portion of the mast being assembled into the mast;

FIG. 17 is a perspective view of the partially assembled rig, showing a further mast section being positioned by the crane; and

FIG. 18 is a plan view of the rig fully assembled rig and peripherals used therewith.

### DETAILED DESCRIPTION

Rather than rely upon the use of large and expensive mobile cranes for assembly of the modular drilling rig elements into a useable drilling rig, the modular mobile rig 10 hereof utilizes an integrated, on-board, crane for assembly and disassembly thereof. The crane thus forms an integral part of the assembled rig, and thus can also be used to bring tools and supplies to the rig floor.

The modular mobile rig generally comprises a plurality of modular components, primarily structural elements, and is configured to be assembled at a drilling site without the need for a mobile crane to lift and position the modular components into the rig. During assembly, the modular components which form the lower box of the platform are first deployed using a long bed truck or trailer, whereby the lower box elements can be slid off of the truck or trailer into a near final ground or pad position. Thereafter, the lower box components are interconnected to form a generally rectangular lower box. The crane, integrally preassembled into a collapsible tower, is then delivered to the rig site, and portions thereof are connected to the lower box. The collapsible tower also includes an integral raising mechanism, such as a pair of hydraulic cylinders, which in conjunction with the attachment of the tower to the lower box, enables raising of the crane tower to an upright position, and then additional physical connections between the crane tower and the lower box are made to secure the crane tower, and thus the crane, to the lower box. To this point in the assembly of the rig, no crane is employed.

Next, using the now integrated crane, the remainder of the rig components are lifted to their placement location and then secured into the rig. First, the elements of the modular upper box are lifted over and secured to the lower box, strong backs are lifted and lain over and secured to the upper box, and the drilling floor is lifted in sections and lain over and secured to the strong backs. Then, the mast base is lifted onto and secured to the drilling floor, and the mast tower is lifted into the mast frame in sections, and lifted therein to form the complete mast. Thereafter, the crane lifts the peripheral equipment, for example the drillers' cabin and the draw works, to the drilling floor to complete the assembly of the rig.

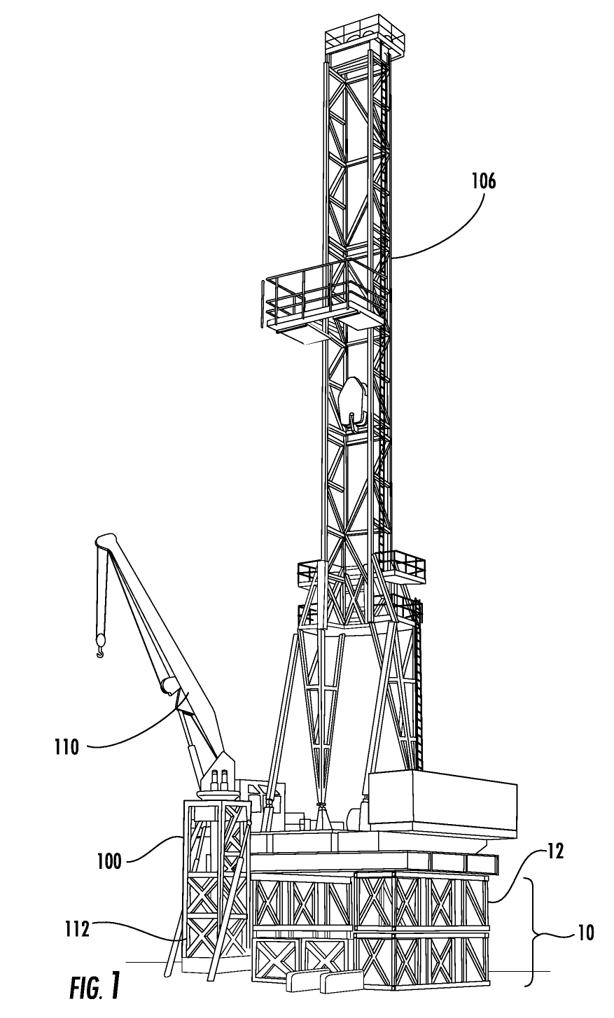

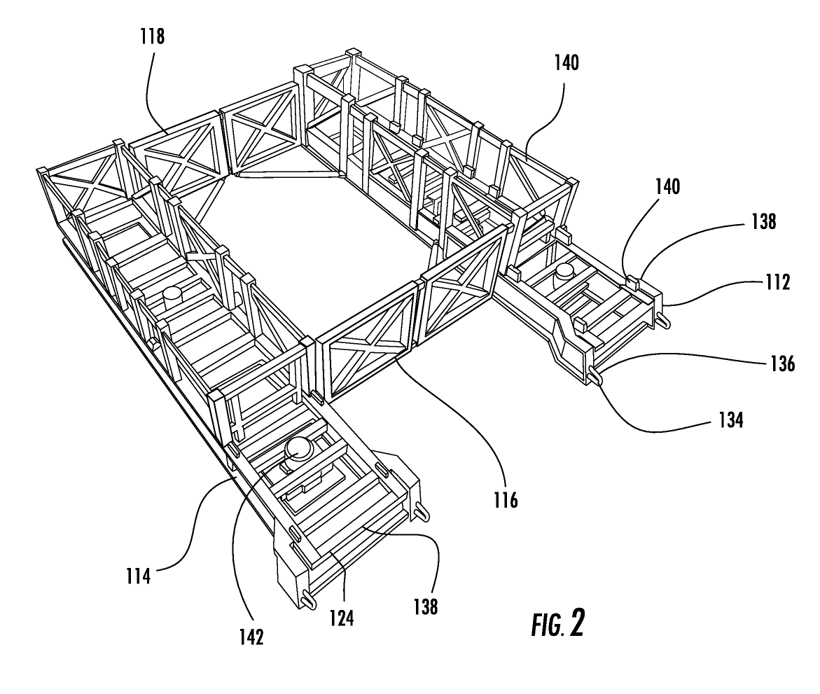

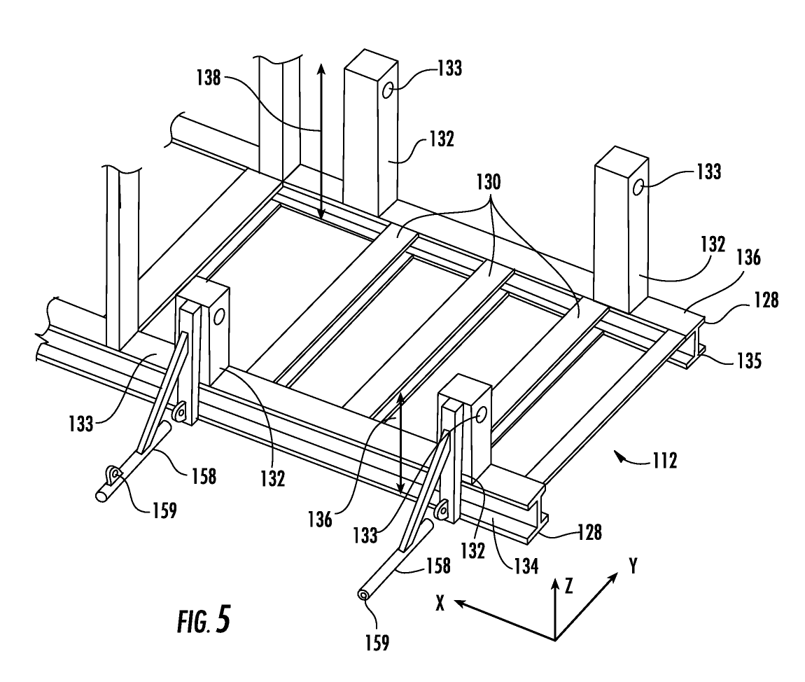

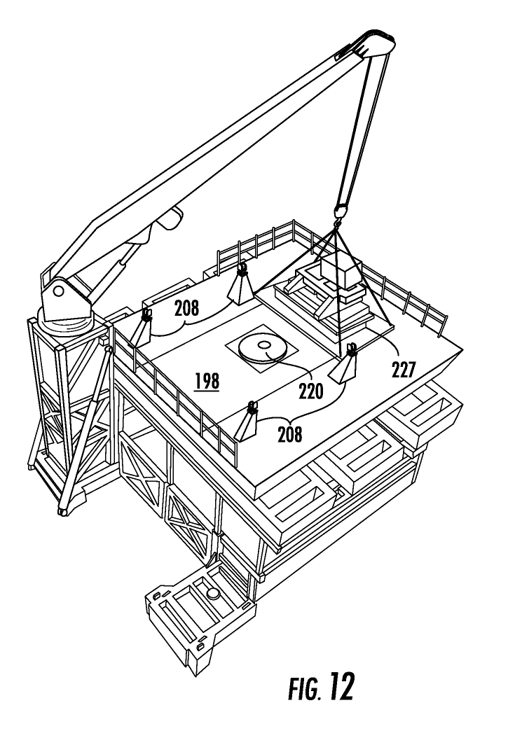

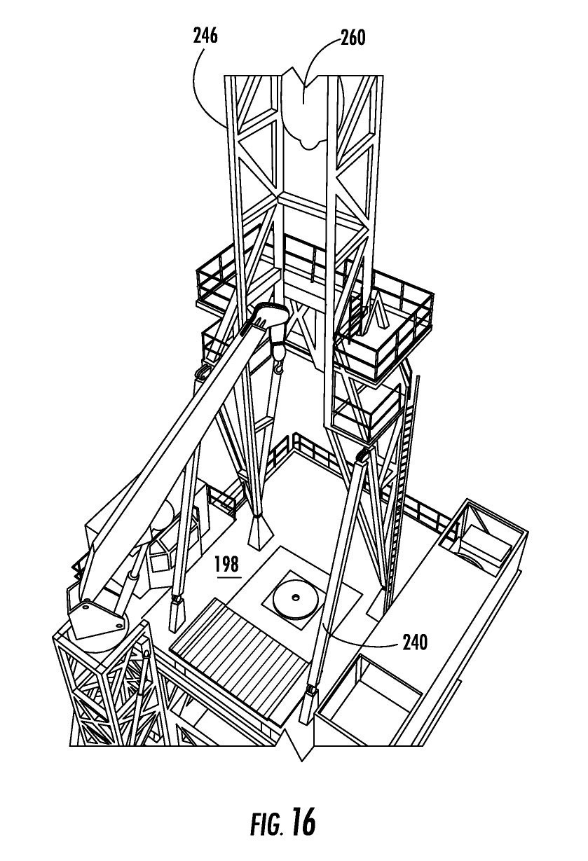

As shown in FIG. 2, to aide in the description of the embodiment, an x-y-z coordinate system is provided, and each of the x, y and z vectors of the coordinate system are mutually orthogonal from each other, and the z direction extends generally perpendicular to the ground or a pad surface, opposed to the direction of gravity. Additionally, two different configurations of the rig are shown, in particular with respect to the crane. In FIGS. 1 to 4 and 9 to 17, a first configuration of the mounting of the crane to the lower box is shown, and in FIGS. 5 to 8, a second configuration of the mounting of the crane to the lower box is shown.

Referring now to FIG. 1, the modular rig 10 hereof generally includes a lower box 100, an upper box 102 located over, and releasably secured to, the lower box 100, a modular floor 104 including strongbacks and rig floor sections located over, and releasably secured to, the upper box 102, a mast assembly 106 mounted on the floor 104 and extending upwardly therefrom generally perpendicular to the floor 104, and a crane base 108, having a crane 110 and crane raising cylinders 111 on the crane base 110 which are releasably secured to one end of one of the first and second boxes 100, 102. Each of the lower box 100, the upper box 102, the floor 104, and the mast assembly 106 are themselves modular and are assembled into the rig 10 in multiple sections.

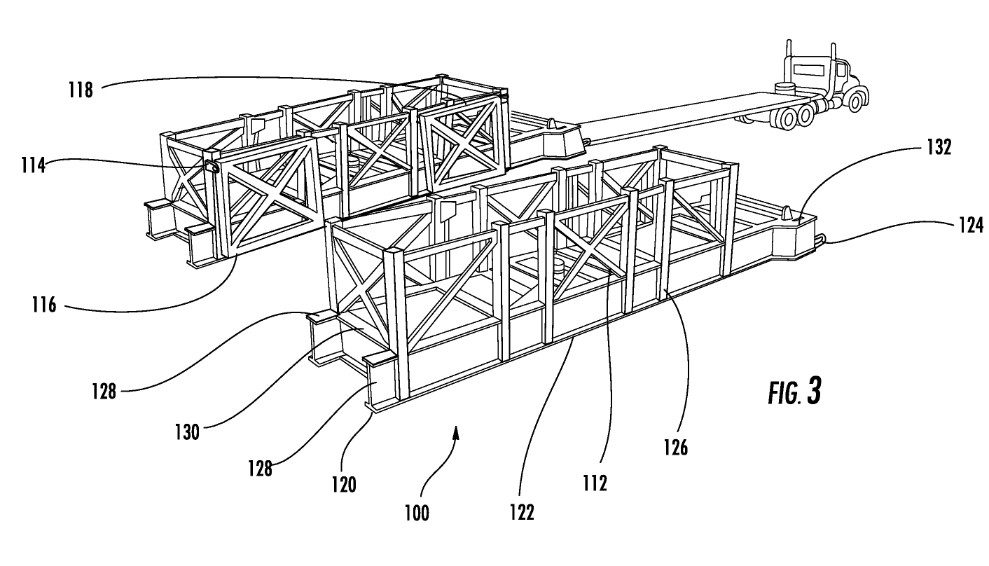

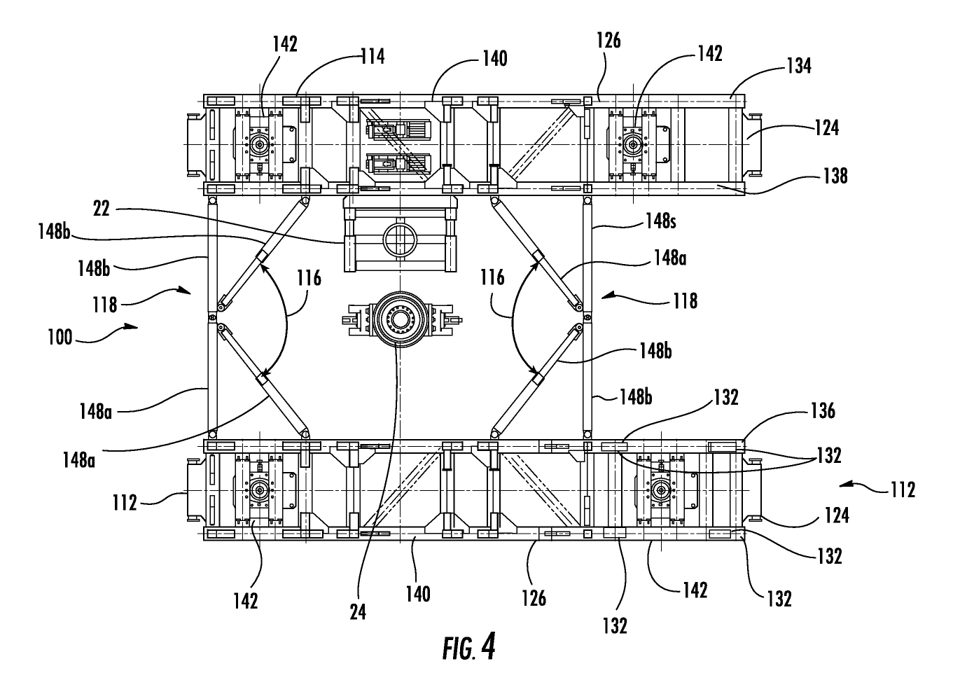

Prior to assembly of the modular mobile rig 10 at a site 12, the site 12 is inspected and laid out, whereby sticks or poles or painted regions of a preformed pad or the land surface delineate the placement location of the modular components forming the lower box 100. In the embodiment the lower box 100 includes a first frame structure 112, a second frame structure 114, and first and second gates 116, 118. As shown in FIGS. 3 and 4, each of the first and second lower frame structures 112, 114 are substantially identical and are sized to be carried on the bed of a flat bed truck or on a trailer and be transportable on local and interstate highways without the need for special permits or escorts. In the embodiments herein, the rig 10 is configured having a lower box 100 having two lower frame structures. However a greater or lesser number thereof may utilized so long as they are individually road transportable and sized to accommodate the mast and the drilling equipment and the additional structural components.

Each of the first and second frame structures 110, 112 include a longitudinally extending base 126 configured from a plurality of I beam sections welded together, the base 126 including opposed, parallel, main rails 128 configured from lengths of I beam extending in the X direction and intermittent, spaced, cross rails 130 configured from lengths of I beam extending therebetween in the Y direction and welded at their opposed ends 132 to the opposed, generally parallel to one another, main rails 128. The lower surface of the opposed main rails 128 provide a skidding surface, whereby, if desired, the assembled rig 10 may be skidded by up to ten feet.

Extending over each base 126 is an elevation section 140 configured as a rectangular, in section, box, having truss configured side walls, and the elevation section 140 terminates inwardly of the base 126 from the second end of the first and second frame structures 110, 112. The portion of the bases 126 not covered by the elevation sections 140 provide a crane mounting pad 138. Additionally, two walking shoes 142, configured to enable “walking” of the rig by combined lifting, and lateral movement thereof, are secured in the each of the bases 126. Additionally, as shown in FIG. 4, a BOP frame 22 may be provided on second frame structure 114 when second frame structure 114 is delivered and assembled into the lower box, and later moved directly below the opening in the rotary table in the yet to be assembled drilling floor, such that a blowout preventer 24 may be located thereover after assembly of the rig 10.

The lower frame structures 112, 114 are nearly identical, except for the location of the gate sections 148 used to form gates thereon. Each lower frame structure includes two gate sections 148a and 148b connected thereto by a hinged connection, and the gate sections 148a, b are located on opposite sides of the lower frame structures 112, 114 so that when the lower fame sections 112, 114 are located on the ground for assembly into the lower box 100, the gate sections are on the sides of the frame sections 112, 114 facing each other.

Once the trailer carrying one of the lower frame structures 112, 114 is positioned in alignment with the placement location of the lower frame structure, the first end 120 of the frame structure 112, 114 is pulled, pushed, or accelerated off the back end of the trailer, and located at one end of the placement location therefor. The frame structure may be pulled off the trailer with a vehicle and chains, a wireline or cable and a winch, or other such equipment, and the bed of the trailer may be equipped with rollers to make removal of the frame structure easier. Once the first end 120 of the frame structure, as shown for frame structure 114 in FIG. 3, is on the pad or the earth's surface, the truck, or the truck pulling the trailer pulls away, and the frame structure underside 122 moves over the rollers at the back of the bed until the second end 124 drops off of the trailer. Both of the first and second frame structures 112, 114 are located at the site in this manner.

As shown in FIG. 4, the first and second frame structures 112, 114 extend generally parallel to one another, with a gap therebetween. Once the frame structures are positioned close to their final relative position, the gate sections 148a, b are swung out from the facing sides of the frame structures 112, 114, and a cross bar 116 is connected between the gate sections 148 and the adjacent side of the frame elements 112, 114 to ensure that the gate elements 148 extend perpendicularly from the side of the frame sections 112, 114. The gate sections 148a, b are then connected by pin connections or the like to form finished gates 118, and to yield, at this point in the assembly of the rig 10, a continuous interconnected lower box 100. If the frame elements 112, 114 are improperly aligned, they may be pushed or pulled into position with the delivery vehicle, or winched together using a travelling block type winch and cable, or by other means.

To this point, no crane has been needed to position the assembled portions of the modular rig 10. However, once the lower box 100 is in place and assembled, the remaining elements which are located above the first box 100 must be lifted onto the first box 100, and thus a lift mechanism, such as a mobile crane, must be employed. However, here a rig dedicated crane is provided, and assembled onto the lower box 100, before the remaining rig elements which must be lifted are deployed. The rig dedicated crane is configured to be both capable of raising all of the rig modules into position for assembly into the completed rig 10, and be collapsible and sized to be accommodated on the bed 20 of a truck or trailer and transportable over the highway without the need for special permits or escort vehicles.

As shown in FIG. 5, in one embodiment, on the crane mounting pad 138 at the second end 124, on each main rail 128 are welded two pivot plates 132, and each of the two pivot plates 132 on a first rail 134 of the main rails 128 extend in the Z direction therefrom and includes a crane pivot 133 opening therein which extends generally in the X direction, to which a support upright of the crane tower will be secured in a manner such that the support upright can swing through an arc centered at the pivot opening, and each of the two pivot plates 132 on the second rail 135 of the main rails 128 extend in the z direction and include a crane pivot opening 133 therein which extends generally in the X direction, to which a support upright of the crane tower will be secured in a manner such that the support upright can swing through an arc centered at the pivot opening 133. The elevation or height 136 of the centers of the pivot openings 133 in the pivot plates 132 on the first rail 134 is less than the elevation or height 139 of the centers of the pivot openings 133 in the pivot plates 132 on the second rail 134. In FIG. 5, the pivot plates 132 are shown as capped sections of rectangular tubular welded to the top of the I beams of the first and second rails 134, 135. However, a thick flat steel plate welded to the top of each rails 134, 135 and supported in the X-direction by welded gussets is also possible. To attach the lifting cylinder 111 to the lower box, a lifting support 158 is cantilevered from the outboard side of the first rail 134. A lifting support opening 159, to which an end of the lifting cylinder 111 can be pivotally connected, is disposed thereon distal from the side of first rail 134.

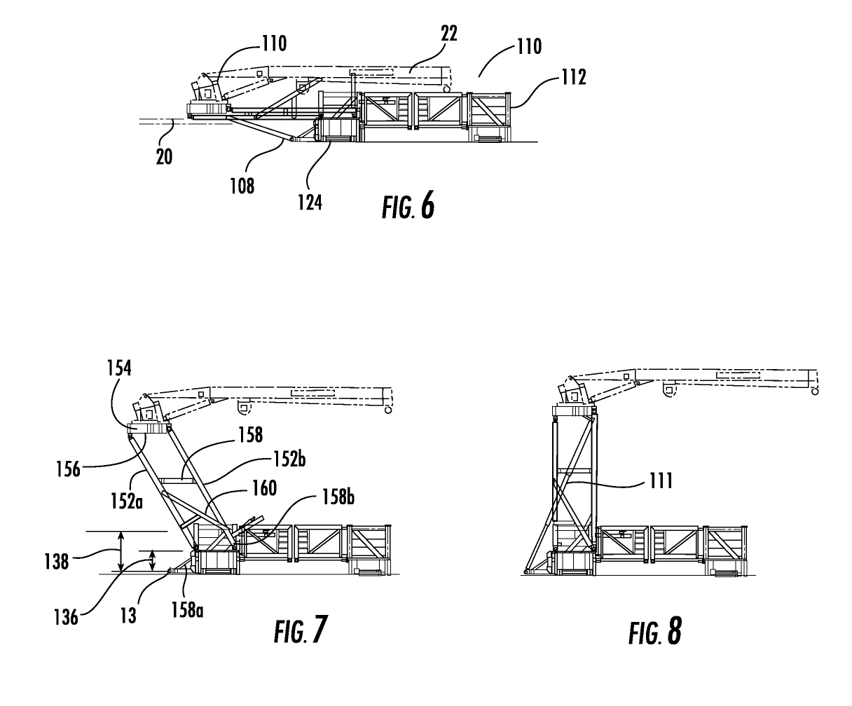

Referring now to FIGS. 6 to 8, delivery of the crane 110, and assembly thereof into the rig 10 having the crane mounting pad 138 configuration of FIG. 5, are shown. In this embodiment, the crane 110 is supported on a crane base 108, and connected to the crane mounting pad 128 at the second end 124 of one of the first and second frame structures 112, 114, in the embodiment frame structure 112, and then moved from a nearly horizontal position as shown in FIG. 6 to a vertical position shown in FIG. 8 using integrally provided crane raising cylinders 111.

Crane base 108 when fully deployed is a generally rectangular, in section, box which is transportable in a collapsed state and configured to be erected into an upright state on site. As shown in the upright state in FIG. 8, the crane base 108 includes four uprights 152a-d forming the corners of the crane base 108. The uprights 152a-d are pivotally connected at a lower end thereof to the pivot plates 132 on the crane mounting pad 138 of the frame section 112 (FIG. 5), and pivotally connected at their opposite ends to the crane platform 154. Specifically, uprights 152a and d are connected to the underside of the crane platform 154, and uprights 152c and d are attached to the side of the crane platform 154 opposite to the side where uprights 154a and d are connected, and above the underside 156 of the crane platform 154. Each of the uprights 154a to d is preferably of the same length. Hence, the height of the pivot openings 133 which are connected to the lower end of uprights 152a and d above the base 126 is less than height of the pivot openings 133 which are connected to the lower end of uprights 152b and c, and this difference is the difference between elevation 139 and elevation 136 of the pivot openings 133.

The side of the crane base 108 bounded by uprights 152a and 152b, the crane platform 154, and the side of the crane base 108 bounded by uprights 152d and 152c form a portion of a trapezoid, more particularly a parallelogram, the profile of which changes as the and the crane base 108 is moved from a collapsed state on the bed of a trailer as shown in FIG. 6 to the upright position of the crane base 108 of FIG. 8. In the erected state of the crane base 108 of FIG. 8, the side of the crane base 108 bounded by uprights 152a and 152b and the crane platform 154, and the side of the crane base 108 bounded by uprights 152d and 152c, are cross braced by braces extending between the uprights 152a and 152b and between the uprights 152d and 152c. Specifically, a horizontal brace 158, and an angled brace 160, extend between the uprights 152a and 152b and between the uprights 152d and 152c. To enable this structure in a collapsible crane base 108, the first ends of the angled braces 160 are rigidly connected to the uprights 152a and d, and the second ends are releasably connected to the upright 152b, c. The horizontal braces 158 are pivotally connected to the uprights at their opposed ends. Additionally, the side of the crane base 108 formed with uprights 152a, d includes fixed bracing. In the embodiment, the angled braces 160 are affixed to the uprights 152a and d using a plate and rivet construction, and the second ends thereof are connected to uprights 152b, c using a pin connection. One end of the lifting cylinder 111 is attached, through a hinged connection, to the underside of the crane support 108 on the same side thereof connected to the upper ends of uprights 152b and c.

As can be appreciated from FIG. 5, the crane 110 is transported with the boom thereof in a horizontal collapsed state, such as on the bed 20 of a trailer or truck. As a result, the crane 110 and the collapsed crane base 108 on which it is mounted, are together on the order of 8 to 10 feet high. Where the bed of the truck or trailer is 3.5 feet high, the crane 110 and crane base 108 are sized to fit under interstate and other highway underpasses. Additionally, in transit, the crane 110 boom 22 extends horizontally, generally parallel to the bed 20. The width of the crane base 108 is on the order of 12 feet on a side, and hence the width of the sides formed with uprights 152d and a, and 152c and b as the sides thereof, is on the order of ten feet wide. Hence, the crane 110 and crane base 108 are no wider than the bed 20 of the truck or trailer, and can be delivered without special requirements, such as permits or escort vehicles.

The crane base 108, in the collapsed state, is delivered to the rig site on the back of a flat bed truck or trailer with the uprights 152a and d located below, and generally parallel to, uprights 152b and c. To enable connecting of the crane base 108 in its collapsed state to the lower box 100, the height of the pivot openings 133 above the ground or pad surface are configured to align with the delivery elevation of the pinning locations of the lower ends of the uprights 152, with the pivot openings 133 connecting to the pinning opening locations of the lower ends of uprights 152a and d located a shorter distance from the pad or ground than the pivot openings 133 connecting with the pining locations of the lower ends of uprights 152b and c. This difference in height is the same as the difference in elevation or height between the pinned location of the upper ends of the uprights 152b,c to the crane platform 156 and the location of the pinned location of the upper ends of the uprights 152a, d to the crane platform 156. Thus, an imaginary line drawn from the pinning location of the pivot openings 133 where uprights 152a and b are pinned, and an imaginary line drawn from the pinning location of the pivot openings 133 where uprights 152c and d are pinned, form the fourth side of the parallelogram of the uprights 152 and the crane platform 156. This configuration of the heights of the pivot openings 133 to the lower ends of the uprights 152 and the pinning locations of the upper ends of the uprights 152 to the crane platform 156 ensures that the crane base 108 can be collapsed to the state thereof in FIG. 5 without interference between the uprights 152 and other structural components thereof, and thus the collapsed crane base 108 can be laid generally flat on the bed 20 or the truck or trailer. Additionally, as the base is raised, the orientation of the crane boom 22 and crane platform 156 with respect to the ground, i.e., in the x and y directions, remains the same.

To connect the crane to the lower base 100, the truck or trailer is maneuvered, and thus the collapsed crane base 108 thereon is maneuvered, to align the pin openings of the uprights 152a-d with the pivot openings 133 of the pivot plates 132, and once they are aligned a pin capable of supporting the weight of the crane base 108, crane 110, and any crane load, but sized to allow the ends of the uprights 152 to move with respect to the hinge mounts 158, is pressed through the pin openings in the pivot openings 133 and lower ends of the corresponding uprights 152. Additionally, the free end of the lifting cylinder 111 is pin connected to the lifting cylinder opening 159 such that the lifting cylinder 111 is now connected between the base 126 and the crane platform 156.

The lifting cylinder 111 is a hydraulic cylinder, and a pump, not show, is connected thereto to provide fluid under pressure thereto, causing the piston portion thereof attached to the crane support 156 to move outwardly of the cylinder portion attached to the lifting cylinder opening 159 in the lower box 100. As a result, the collapsed crane base 108 moves from the position thereof in FIG. 6, through the intermediate position of FIG. 7, and into the fully erected position of FIG. 8, while the orientation of the crane boom 22 and the crane platform with respect to the earth's surface stays generally fixed. Once fully erected, pins (Not shown) are inserted into aligned holes (not shown) in the uprights 152b, c and the adjacent end of the elevation section 140, and in the angled supports 160 the uprights 152b, c, to secure raised the crane base 108 in place. Thus, the crane 110 and crane base 108 are now connected to the lower box 100. Of note, the mass of the lower box 100 and its span from the pivoting connections of the uprights 152 and the hinge mounts 156 ensure that the lower box remains on the surface of the ground or pad at the crane base is raised into its upright position, and thus act as a counterweight or counter mass.

In FIGS. 5 to 8, the crane is raised from the side of the lower box 100; specifically it extends out from the side of one of the lower sections 112, 114. In the configuration of the crane of the remaining Figures, the crane is raised from the end of the second end 124 of the lower box 100.

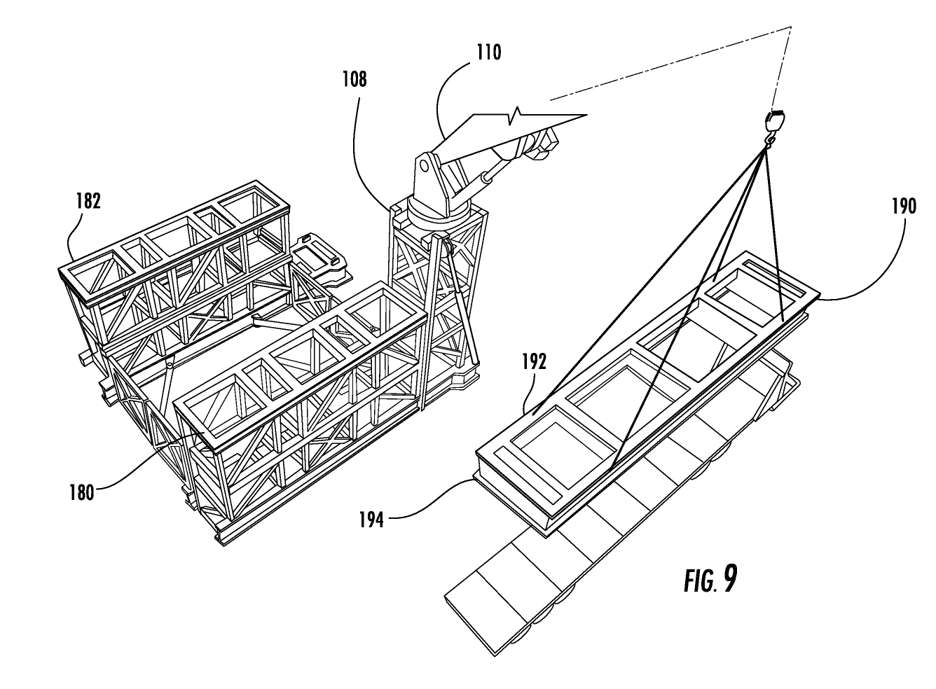

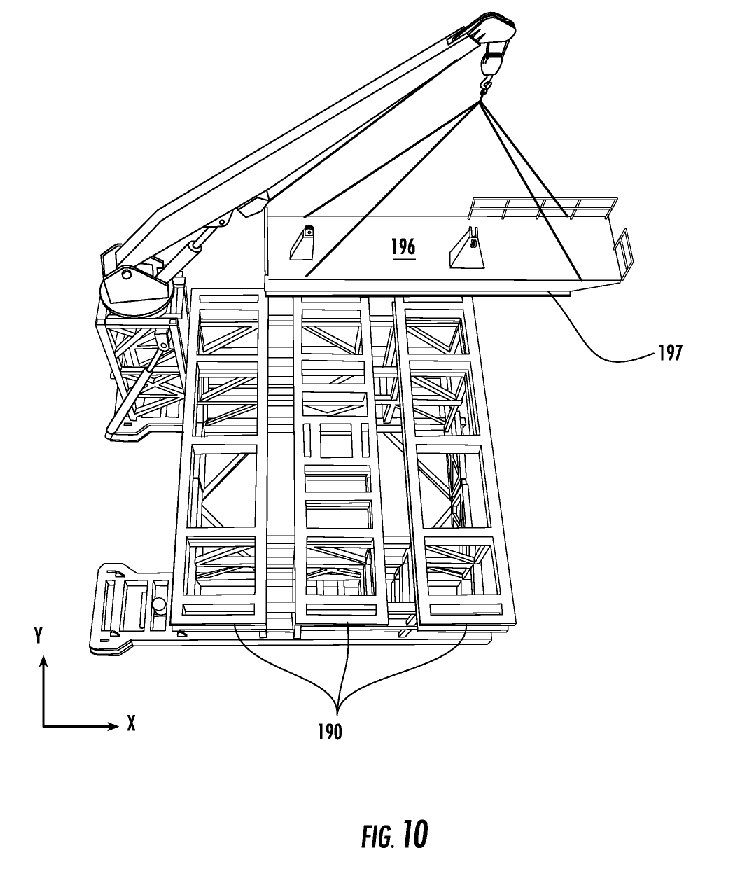

Next, as shown in FIG. 9, the upper box 102 is located on the lower box 100. The upper box 102 includes, in the embodiment, two upper sections 180, 182, each upper section having the same general size and construction as the elevation sections 140 of the lower sections 112, 114. The upper sections 180, 182 have the same general dimensions as the elevation sections 140 of the lower box 100, are delivered on a flat bed truck or trailer, and then individually lifted over the lower sections 112, 114 and placed thereon such that sides of the upper suctions 180, 182 align with the sides of the underlying corresponding elevation sections 140. Once in place, they are pinned or otherwise connected to the lower box 100 to form the upper box 102. Note, that the upper sections 180, 182 forming the upper box 102 do not include gates.

Once the upper box 102 is formed, strongbacks 190, which are likewise rectangular in plan view, are lifted by the crane 110 and positioned across the sections 180, 188 of the upper box 102, crossing over the space therebetween as shown in FIG. 8. Each strongback 190 includes spaced, parallel side sections 192 extending, when positioned on the upper box, in the Y-direction, and, opposed, spaced end sections 194 extending, when positioned on the upper box, in the x-direction. Thus, when positioned, the sides 192 of the strongbacks are generally orthogonal to the rails 198 of the lower box 100. A plurality of the strongbacks 190 are employed, providing a base for the drilling floor. Once the strong backs are in place and form a sub-floor, the drilling floor is installed in sections over the strongbacks as shown in FIG. 9. The strongbacks 190 provide rigidity to the rig 10, allowing the rig 10 to be skidded along the pad or ground surface a short distance, on the order of ten feet, without damaging the rig 10. As a result, once in place, the rig 10 can be skidded from a completed bore to an adjacent location to enable drilling of a second bore hole. Additionally, the walking shoes 142 can be employed to move the rig the same, or longer distances.

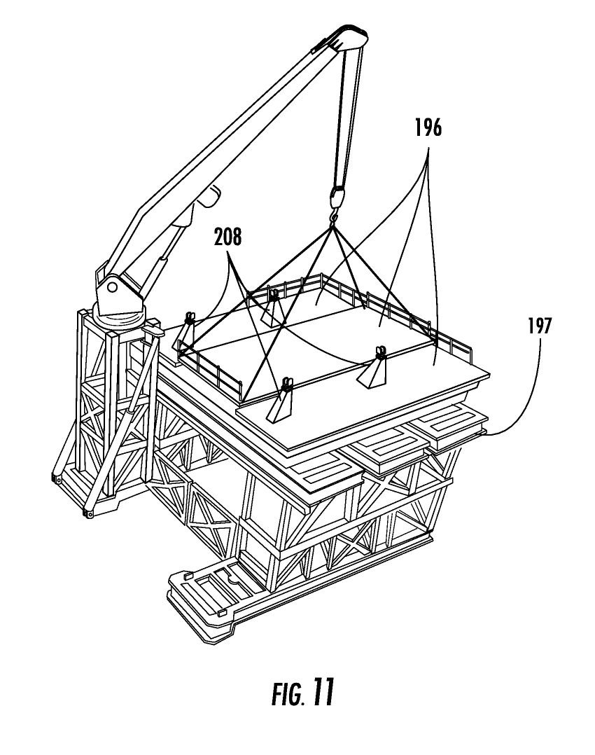

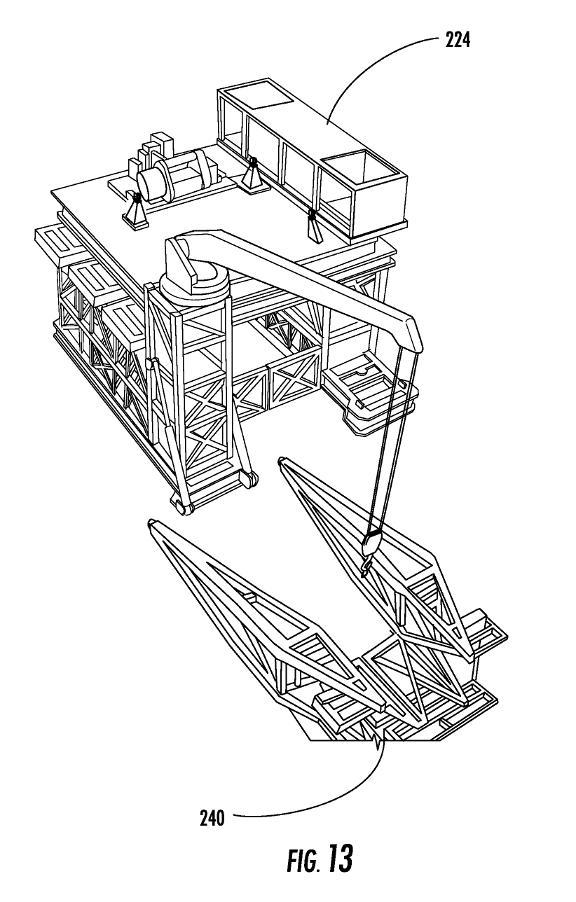

Next as shown in FIG. 10, sections of the drilling floor 198 are located over the strongbacks. The drilling floor is provided and lifted by the crane 110 in sections 196, and each section extends longer in the X-direction than in the Y direction, and the longer side 197 thereof extends across, and generally perpendicular to the sides 192 of the strongbacks 190. Two of the drilling floor sections 196 include mast base supports 208 thereon to which the mast base will be attached. A third of the drilling floor sections 196, located between the two sections having the mask base supports 208 thereon, includes the rotary drive 220 integrally formed therein. At this point in the assembly of the rig 10, a portion of the strong backs 190 extend outwardly in the Y direction from below either side of the drilling floor 198, as shown in FIG. 12.

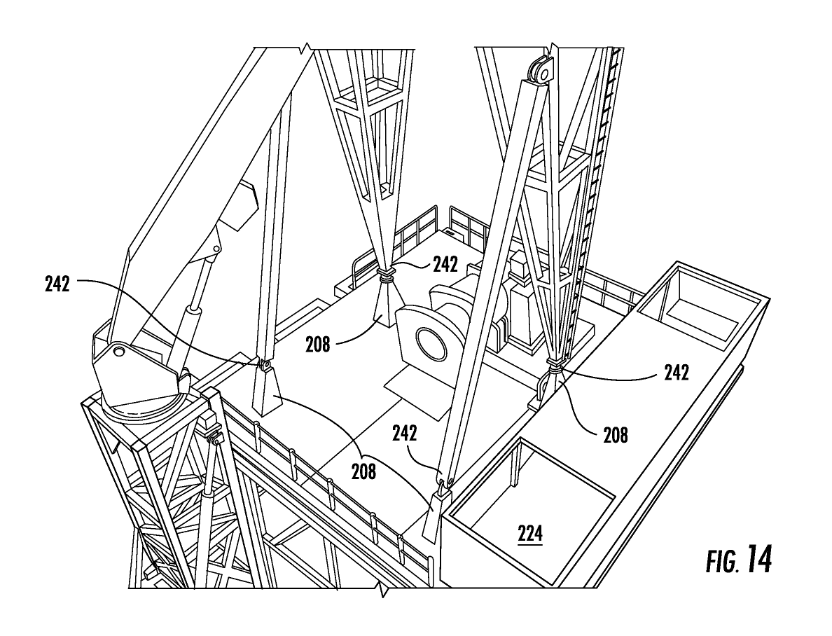

Next, the drawworks 222 is lifted by the crane 210 and located adjacent to the rotary drive 220 in the drilling floor 198. Then, a shed 224 is lifted by the crane, and positioned over a first portion of the strongbacks extending outwardly from the sides of the drilling floor 198, as shown in FIG. 13.

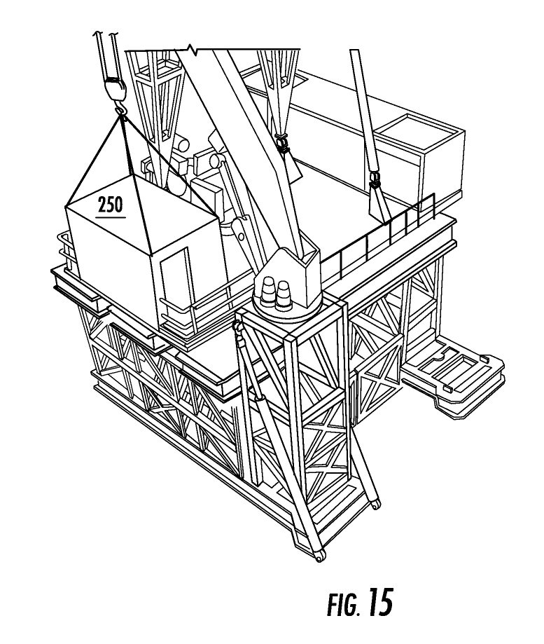

Once the drilling floor 198 is in place, the mast 106 is delivered in sections. The mast 106 is modular, and configured to include a base, 240, a crown 244 and top section 246, and a plurality of lower sections 248 extending between the top section 246 and the base 240. Initially, the base 240 is delivered to the ground adjacent to the partially assembled rig as shown in FIG. 13. The mast base 240 may be delivered in sections, and assembled together on site adjacent to the partially assembled rig 10. Then the crane 210 raises the mast base 240 off of the ground and over the mast base supports 208. Once in position, the lower supports 242 of the mast base 240 are connected and secured to the mast base supports 208 as shown in FIG. 14.

Once the mast base 240 is connected to the mast base supports 208, the driller's cabin 250 is delivered and lifted by the crane 210 and placed on the remaining portion of the strongbacks 190 extending from below the drilling floor 198 opposite to the location of the shed 224 on the strongbacks 190.

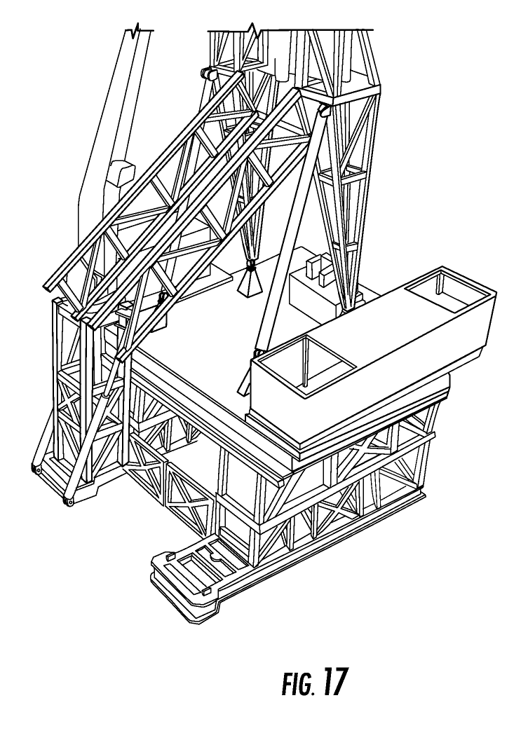

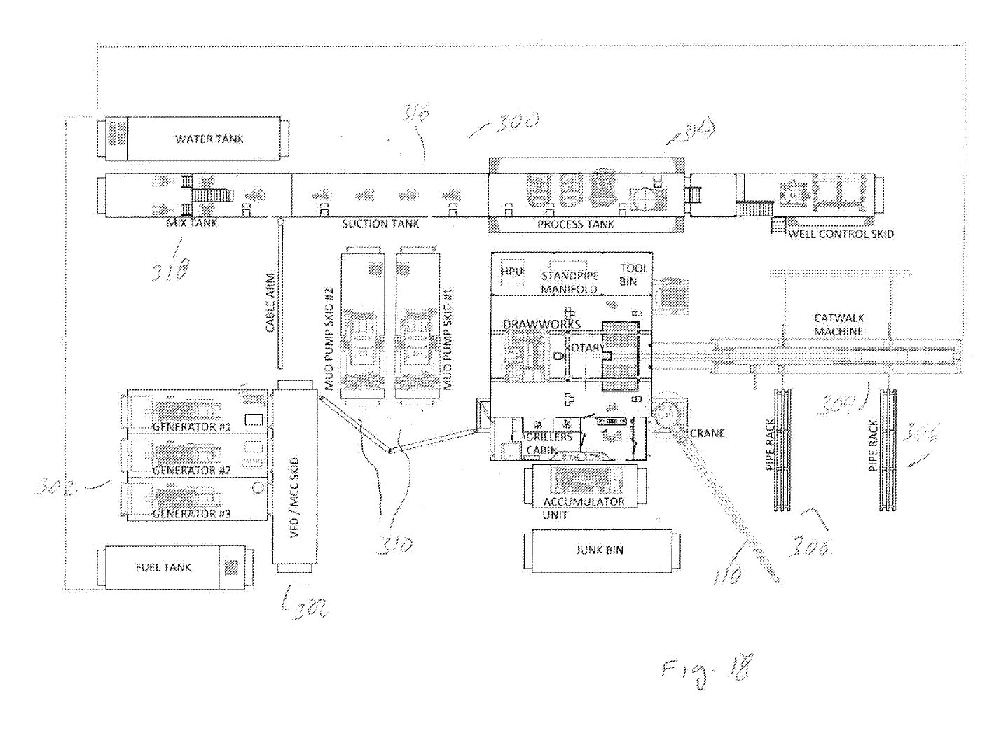

With the operators cabin in place, the crane 210 lifts the crown 244 and top section 246 to the drilling floor, and aligns them with a box shaped opening in the mast base 240. Using the travelling block 260 of the top section and a cable or wireline, the crown 244 and top section 246 are pulled upwardly through the opening to the position thereof shown in FIG. 16. Next, as shown in FIG. 17, the intermediate lower sections 248 are individually lifted by the crane 208 to the drilling floor 198, and the upper end of the uppermost lower section is connected to the lower end of the crown 244 and top section 246. Then, using the travelling block and cable, the uppermost lower section is pulled upwardly in the box like opening. Additional lower sections 248 are raised by the crane 210 to the drilling floor, and connected to the lower end of the previously assembled lower section 248, and then raised by the travelling block until the mast configuration of FIG. 1 is achieved. In one embodiment, the mast is a 138 ft.-750 kip bootstrap design that is telescoped to height; the mast may comprise a racking board configured to hold 20,000 ft. of 5 in. drill pipe.

The pipe rack is then lifted by the crane and positioned for assembly on the mast 106.

With the rig 10 assembled into place, the rig peripherals, such as mud tanks, pipe racks, pumps, a blowout preventer, a generator and the hydraulic and electrical controls associated therewith, the shale shaker, and storage sheds can be delivered to the site and dropped of the bed 20 of a truck or trailer in their in-use place as shown in FIG. 18. Additionally, once a well bore is drilled, the rig 10 may be skidded or walked to a further drilling location. Once drilling operations are completed, the rig peripherals are removed, and the crane 110 is used to remove the modular elements of the rig 10 in the reverse order of which they were assembled, and load them onto the beds 20 of trucks or trailers. Once only the crane 210, crane base 208 and the lower box 100 remain in place, the lifting cylinder 111 is used to lower the crane base 208 onto the bed of a truck or trailer backed against the side thereof, the crane base 208 is unpinned from the lower box 100, and the crane 110 and crane base 208 trucked away. Then the gates are secured against the sides of the first and second frame structures 112, 114, and the frame structures 112, 114 are winched onto the bed of a truck or trailer and transported away. The modular elements can be transported to a storage yard, or taken directly to another drilling site.

FIG. 18 illustrates an embodiment of the rig 10 and drilling peripherals in plan view. Shown are a mud system 300, a power system 302, a catwalk 304, pipe racks 306 and other needed materials and equipment. The mud system 300 includes two mud pumps 310 with super charge pumps and discharge manifold including pulsation dampeners. The mud pumps 310 may be configured to provide discharge rating of 7,500 psi working pressure. The mud pumps 310 may be powered by a 1500 hp AC electric motor.

The mud system may also feature a mud tank system 312 comprising three skids, a process tank 314, a suction tank 316, and a mixing tank 320 for a total of 1000 BBLs of mud. The process tank 314 may have four compartments of approximately 115 BBLs each. The suction tank 316 may have two compartments of 225 BBLs each. The mixing tank 320 may have one compartment of 100 BBLs. The mixing tank 320 may additionally comprise two centrifugal pumps and two mixing hoppers. The tanks may be protected by a fiberglass grating floor structure with a roof. Additional mud processing equipment may include shale shakers, a mud cleaner with a de-sander and de-silter, and a degasser.

In at least one embodiment, the rig power system 302 includes three Caterpillar 3512 diesel generator sets unitized on typical oilfield skids with roofs. Power distribution may be housed in a variable frequency drive (VFD) building 322 with all required transformers and motor control centers (MCC's) for the provided equipment.

In at least one embodiment, the rig includes a blowout preventer (BOP) configured to accommodate a typical 13⅝″×10M three ram plus annular (5M) arrangement. An embodiment may also future a choke manifold and mud/gas separator configured for a two choke (one manual, one hydraulic) system and rated for 10,000 psi working pressure. The choke manifold and a trip tank may be configured on a skid attached to the base of the substructure. Additionally, a BOP accumulator and control unit may also be configured on a skid attached to the base of the substructure. These attachments enable the rig to “walk” without breaking connections.

An embodiment of the invention has been described in a manner whereby the on-board crane assists in assembling the rig. As will be evident to those skilled in the art, the reverse is equally, true and the on-board crane is just as useful and functional in disassembling the rig as it is in assembling.

As the foregoing illustrates, an embodiment of the invention includes an onboard crane that facilitates the assembly and disassembly of a land-based rig, thereby eliminating the costs and delays that arise from the use of separate cranes that are brought to a rig site for assembly and disassembly. In addition, the on-board crane permits the rig modules to be more efficiently sized, thereby reducing problems associated with transporting the modules on public roads to their point of use. Each component, or module, is configured to meet the most stringent size and weight limitations for truckable loads. Most modules may fit in the envelope of 10 ft.×45 ft.×13.5 ft. tall from road to bed, while having a weight not exceeding 80,000 lbs. The mud pump modules may be 12 ft. wide.

Because the on-board crane is literally a part of the rig, components can be assembled faster and more accurately. Unlike using standard rental cranes, with the on-board crane, the drilling mast does not have to be laid out in front of rig prior to being raised. Further, the on-board crane eliminates or reduces the use of expensive and cumbersome hydraulic cylinders or wireline tackle for raising the drill floor, mast, and other components. In addition to its role is assembly and disassembly of the rig, the on-board crane can be used for assembly/handling of components at any time the rig is in operation.

While the foregoing is directed to embodiments of the present invention, other and further embodiments of the invention may be devised without departing from the basic scope thereof, and the scope thereof is determined by the claims that follow.

1. A method of assembling a land-based rig, comprising:
providing a set of modules that can be assembled together to form the rig, wherein the modules include an on-board crane;
assembling the modules, wherein at least some of the modules are assembled into the rig using the on-board crane.

2. The method of claim 1, wherein the on-board crane is installed at a corner of the rig.

3. The method of claim 1, wherein the on-board crane is further utilized in the disassembly of the rig.

4. The method of claim 1, wherein a crane tower associated with the on-board crane is self-elevating and raised using a pair of hydraulic cylinders.

5. The method of claim 1, wherein the on-board crane comprises a boom between 45 and 60 feet.

6. The method of claim 1, wherein a capacity of the on-board crane is 30 tons.

7. The method of claim 1, wherein each module of the set of modules comprises a weight not greater than 80,000 lbs.

8. The method of claim 1, wherein each module of the set of modules is configured to fit an envelope of: (1) a width not greater than 12 feet, (2) a length not greater than 45 feet, and (3) a height not greater than 13.5 feet.

9. A lifting apparatus for a drilling ring, comprising:
a crane platform having a first side, a second side, and a perimeter wall extending between the first wall and the second wall;
a plurality of supports extending from the crane platform, wherein two of the supports are moveably connected to the crane platform at a first distance from the first side and at least one additional support is moveably connected to the crane platform at a second distance from the first surface, different than the first distance;
a crane on the crane platform; and
a lifting cylinder attached to the crane platform; wherein
the plurality of supports are moveable with respect to the crane platform between a first position extending generally parallel to the earth's surface and a second position wherein they extend upwardly from the earth's surface.

10. The lifting apparatus of claim 9, wherein the crane platform forms one side of a trapezoid.

11. The lifting apparatus of claim 10, wherein the crane supports form additional sides of the trapezoid.

12. The lifting apparatus of claim 9, wherein the crane is positionable on a lower box of a drilling rig.

13. The lifting apparatus of claim 13, wherein the lifting cylinder is extendable between the crane platform and a lower box of a drilling rig.

14. A modular rig, comprising:
a first box;
a crane platform having a first side, a second side, and a perimeter wall extending between the first wall and the second wall;
a plurality of supports extending from the crane platform, wherein at least one of the supports is moveably connected at a first end thereof to the crane platform at a first distance from the first side of the crane platform and at a second end thereof to the first box, and at least one additional support is moveably connected to the crane platform at a second distance from the first surface, different than the first distance, and at a second end thereof to the first box;
a crane on the crane platform; and
a lifting cylinder attached at a first end thereof to the crane platform and at a second end thereof to a component of the first box; wherein
the plurality of supports are moveable with respect to the crane platform between a first position extending generally parallel to the earth's surface and a second position wherein they extend upwardly from the earth's surface.

15. The modular rig of claim 14, wherein the crane platform forms one side of a trapezoid.

16. The modular rig of claim 15, wherein the crane supports form additional sides of the trapezoid.

17. The modular rig of claim 14, further comprising an upper box disposed on the lower box, wherein the upper box is liftable into position over the lower box by the crane.

18. The modular rig of claim 17, wherein the upper box includes at least two modules, and each of the modules weigh less than the lifting capacity of the crane, and the weight of the modules in combination exceeds the lifting capacity of the crane.

19. The modular rig of claim 18, further comprising a floor on the upper box, the floor includes at least two modules, and each of the modules of the floor weigh less than the lifting capacity of the crane, and the weight of the modules of the floor in combination exceeds the lifting capacity of the crane.

20. The modular rig of claim 19, further comprising a mast on the floor, the mast includes at least two modules, and each of the modules of the mast weigh less than the lifting capacity of the crane, and the weight of the modules of the mast in combination exceeds the lifting capacity of the crane.
